(19) United States
(12) Patent Application Publication
(10) Pub. No.: US 2015/0226962 A1
(43) Pub. Date: Aug. 13, 2015

(54) MULTI-LAYER THIN FILM FILTER AND METHOD OF BUILDING THEREFOR

(71) Applicant: Eugene Kashdan, Tel Aviv (IL)

(72) Inventor: Eugene Kashdan, Tel Aviv (IL)

(21) Appl. No.: 14/421,977

(22) PCT Filed: Aug. 29, 2012
(86) PCT No.: PCT/IB2012/054429

§ 371 Date: Feb. 16, 2015

(51) Int. Cl. G02B 27/00; G02B 6/293; G02B 5/28

(52) U.S. Cl. CPC G02B 27/0012; G02B 5/288; G02B 6/29361; G02B 6/2938

(57) ABSTRACT

A multi-layer thin film filter (36) has a transmission spectrum that is within a preset tolerance of a preselected transmission spectrum. The filter includes spaced apart layers (42ₐ₁, 42ₐ₂, 42ₐ₃, . . . ) of a material having a one refractive index; and layers of another material (42_{b2}, 42_{b3}, . . . ) having a higher refractive index. The latter layers (42_{b2}, 42_{b3}, . . . ) space apart the former layers (42ₐ₁, 42ₐ₂, 42ₐ₃, . . . ). The thicknesses of the individual layers (42ₐ₁, 42_{b1}, 42ₐ₂, 42_{b2}, 42ₐ₃, 42_{b3}, . . . ) are set by selecting initial values and then repeatedly computing a transmission spectrum by solving Maxell's equations and executing a nonlinear optimization algorithm until the a computed transmission spectrum converges to within the preset tolerance of the preselected transmission spectrum. By designing a filter (36) accordingly, a transmission spectrum can be achieved having high transmittance within a desired region and very low transmittance elsewhere.

### BACKGROUND

FIG. 1 illustrates an example communication system implementing wavelength division multiplexing. Each of optical transmitters 18a, 18b, 18c, 18d, 18e receives a signal corresponding to an individual communication, and each of the communication signals have different wavelength. The transmitters 18a, 18b, 18c, 18d, 18e send their respective signals along optical waveguides 20a, 20b, 20c, 20d, 20e, respectively, to a wavelength division multiplexer 22, which combines (“multiplexes”) the individual signals so that they share a communication medium, an optical waveguide link 24. Eventually, the signals traveling along the optical waveguide link 24 reach a wavelength division demultiplexer 26, which separates (“demultiplexes”) the signals from the individual transmitters 18a, 18b, 18c, 18d, 18e and sends them along optical waveguides 28a, 28b, 28c, 28d, 28e to corresponding individual receivers 30a, 30b, 30c, 30d, 30e, respectively.

FIG. 2 illustrates an example implementation of the wavelength division demultiplexer 26. The multiplexed signals arriving from the optical waveguide link 24 are directed to filters 32a, 32b, 32c, 32d, 32e, each of which allows a different range of wavelengths to pass to the optical waveguides 28a, 28b, 28c, 28d, 28e, respectively. The range of wavelengths for the optical waveguide 28a corresponds to the range of wavelengths from the optical waveguide 20a (FIG. 1), the range for the optical waveguide 28b corresponds to the range from the optical waveguide 20b, and so on.

FIG. 3 illustrates the transmission spectra 34a, 34b, 34c, 34d, 34e (not to scale) of individual channels corresponding to the signals flowing along the optical waveguides 28a, 28b, 28c, 28d, 28e (after the demultiplexing) to the receivers 30a, 30b, 30c, 30d, 30e, respectively. Due to physical limitations in the system, including the filters 32a, 32b, 32c, 32d, 32e, the transmittance is never as much as 100 percent. Also, due to noise in the system, the transmittance below a certain value cannot be discerned and therefore is not illustrated in FIG. 3. The present example shows the processing of five communication channels, but it is understood that communication systems are developed to accommodate many more channels.

As it becomes desirable to accommodate still more channels, the wavelength ranges of individual channels are brought closer together. FIG. 4 shows overlaps in the transmission spectra of the numerous channels. When the overlaps become too great, cross-talk (or inter-symbol interference) between the individual channels reduces the signal-to-noise ratio and as a result increases signal attenuation. Accordingly, additional channels cannot be added. Thus, it would be desirable to be able to accommodate more channels without experiencing the deleterious effects of the cross-talk.

### SUMMARY

The present inventor realized that, to reduce the afore-described problems of channel cross-talk, the filters used for the demultiplexing should be redesigned to provide higher transmittance for most wavelengths within the filter's designated wavelengths and negligible transmittance outside those wavelengths. Such filters are useful not only in wavelength division multiplex communication systems but also in other uses as discussed in more detail below.

The invention may be embodied as a method of building a multi-layer thin film filter to have a transmission spectrum that is within a preset tolerance of a preselected transmission spectrum. The filter has layers of a lower refractive index material and layers of a higher refractive index material. The method includes: setting thicknesses of individual layers by (1) selecting a first value for the thickness of a preset number of layers of the lower refractive index material and (2) computing the thicknesses of the same preset number of individual layers of the higher refractive index material by: setting initial values for the thicknesses of each of the layers, the thicknesses being expressed as a second value plus an initial vector of deviations; computing a transmission spectrum by solving Maxell's equations based on the first value, the second value, and the deviation vector; executing a non-linear optimization algorithm to compute a new deviation vector such that a new computed transmission spectrum is closer to the preselected transmission spectrum, the non-linear optimization algorithm constrained to suggest individual layer deviations that are between preset minimum and maximum values; and repeatedly solving Maxwell's equations and executing the non-linear optimization algorithm until the deviation vector converges to a final deviation vector such that the computed transmission spectrum converges to within the preset tolerance of the preselected transmission spectrum. The method also includes: forming a first layer of the higher refractive index material; adding to the first layer a layer the lower refractive index material; and repeatedly adding layers alternating between the higher and lower refractive index materials. The thicknesses of the layers of the lower refractive index material are equal to the first value and the thicknesses of the layers of the higher refractive index material are equal to the second value plus the deviations of the final deviation vector.

The invention may also be embodied as a multi-layer thin film filter having a transmission spectrum that is within a preset tolerance of a preselected transmission spectrum. The filter includes: spaced apart layers of a material having a lower refractive index; and layers of a material having a higher refractive index spacing apart the layers of the lower refractive index material. The thicknesses of the individual layers are set by (1) selecting a first value for the thickness of a preset number of layers of the lower refractive index material and (2) computing the thicknesses of the same preset number of individual layers of the higher refractive index material by: setting initial values for the thicknesses of each of the layers, the thicknesses being expressed as a second value plus an initial vector of deviations; computing a transmission spectrum by solving Maxell's equations based on the first value, the second value, and the deviation vector; executing a non-linear optimization algorithm to compute a new deviation vector such that a new computed transmission spectrum is closer to the preselected transmission spectrum, the non-linear optimization algorithm constrained to suggest individual layer deviations that are between preset minimum and maximum values; and repeatedly solving Maxwell's equations and executing the non-linear optimization algorithm until the deviation vector converges to a final deviation vector such that the computed transmission spectrum converges to within the preset tolerance of the preselected transmission spectrum. Based on the selecting and the computing, the thicknesses of the layers of the lower refractive index material are equal to the first value and the thicknesses of the layers of the higher refractive index material are equal to the second value plus the deviations of the final deviation vector.

Embodiments of the present invention are described in detail below with reference to the accompanying drawings, which are briefly described as follows:

### BRIEF DESCRIPTION OF THE DRAWINGS

The invention is described below in the appended claims, which are read in view of the accompanying description including the following drawings, wherein:

FIGS. 1 and 2 illustrate an example of a known communication system implementing wavelength division multiplexing;

FIGS. 3 and 4 illustrate transmission spectra of individual channels implementing the wavelength division multiplexing of FIGS. 1 and 2;

FIG. 5 illustrates an example multi-layer thin film filter built according to an example method embodiment of the invention;

FIG. 6 illustrates transmission spectra in the context of the example method embodiment used to build the multi-layer thin film filter of FIG. 5;

FIG. 7 provides a flowchart representing the method embodiment of FIGS. 5 and 6;

FIG. 8 provides an example of the thicknesses of layers of a filter built according to the embodiment of the invention referenced in FIG. 7; and

FIG. 9 is a plot of the computed spectrum for the multi-layer thin film filter of FIG. 8.

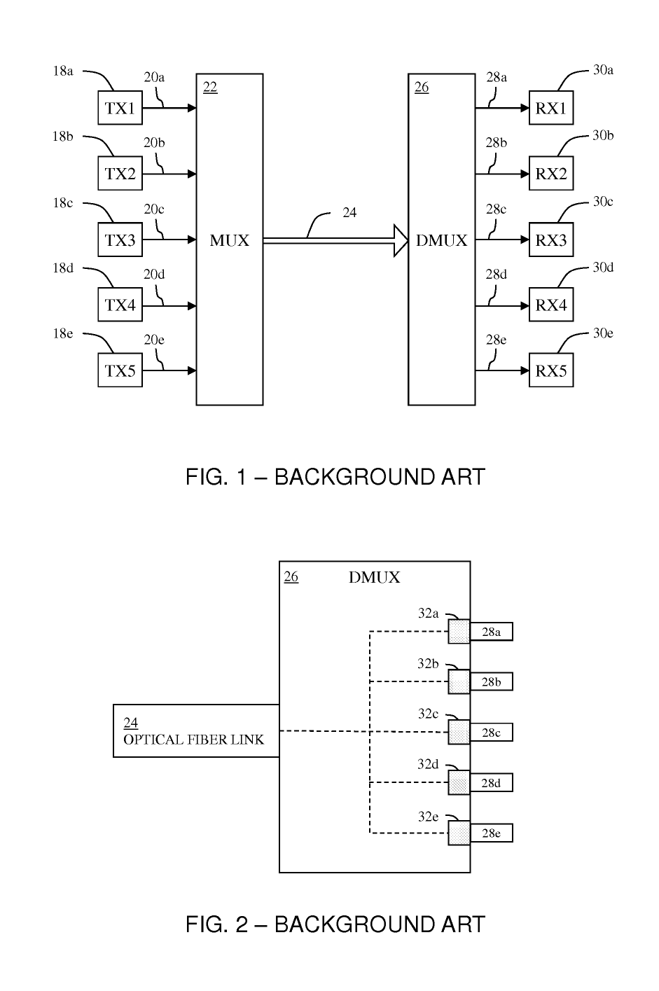

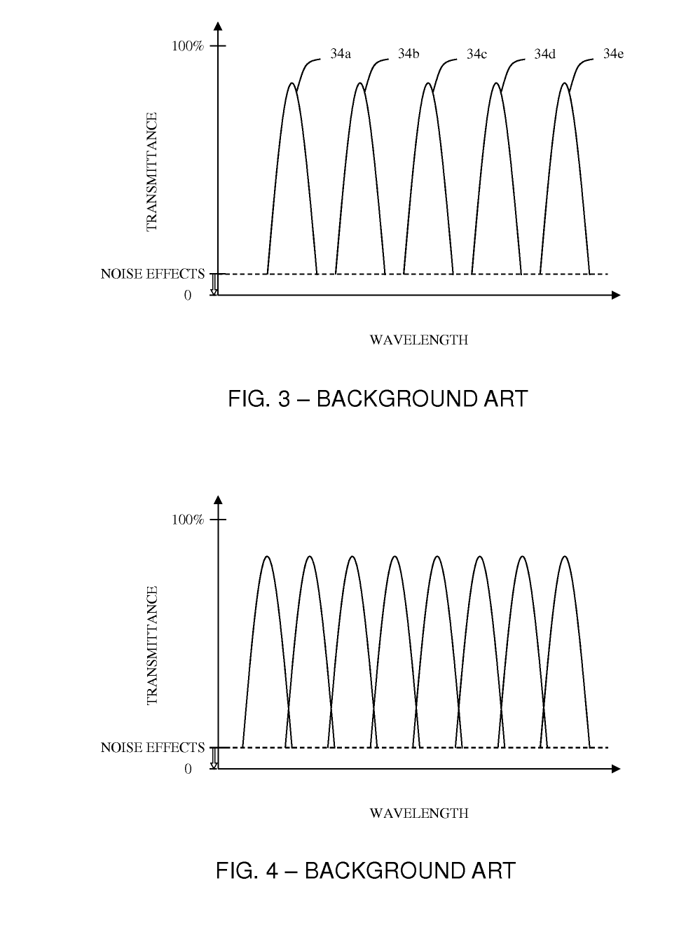

### DETAILED DESCRIPTION

The invention summarized above and defined by the claims below will be better understood by referring to the present detailed description of embodiments of the invention. This description is not intended to limit the scope of claims but instead to provide examples of the invention. Described first are embodiments of a method of building multi-layer thin film filters. Described later are embodiments of multi-layer thin film filters, which may be built according to the described methods.

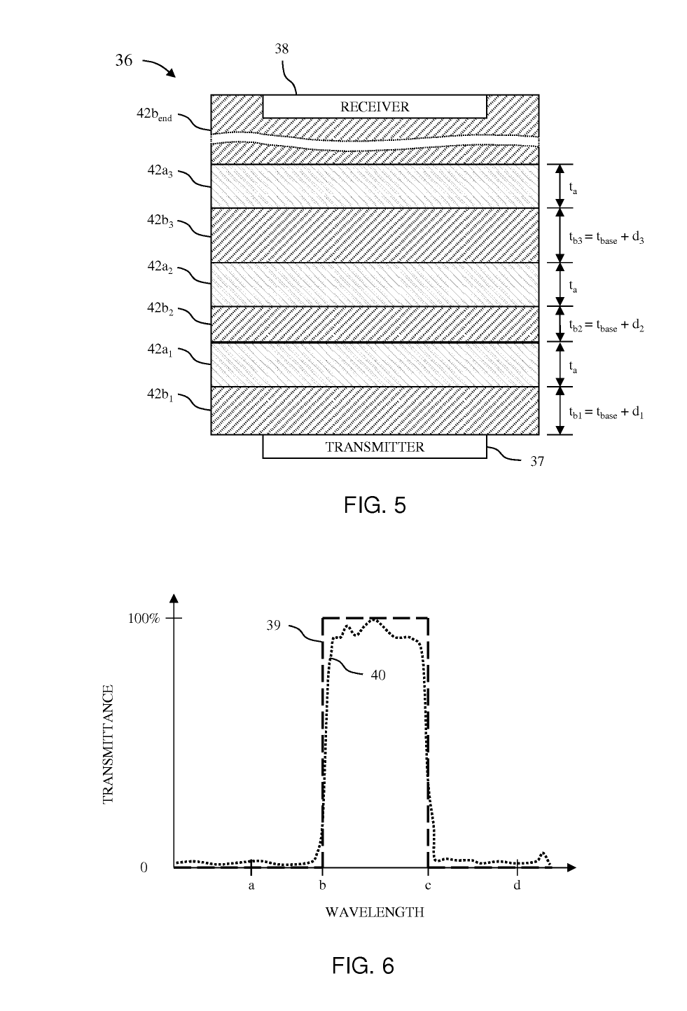

The first embodiment of the invention is a method of building a multi-layer thin film filter, such as example filter 36 illustrated in FIG. 5 operating between a transmitter 37 and a receiver 38. The drawing is not to scale. The thicknesses of the layers may be very small relative to the layer dimensions normal to the direction of light propagation.

In the present embodiment, a desired or ideal transmission spectrum is selected (also termed “preselected” in the context of a series of steps) as the goal for the filter's performance. An example of such ideal transmission spectrum is spectrum 39 plotted in FIG. 6 and described mathematically as:

for a<wavelength<b, transmittance=0;

for b<wavelength<c, transmittance=100%;

for c<wavelength<d, transmittance=0.

The transmittance at wavelengths less than a and greater than d are not relevant in the present example. Other examples of ideal transmission spectra involve selecting 98% or 95% transmittance for wavelengths between b and c. (In the present disclosure, the term “ideal transmission spectrum” references a design goal to which the final computed transmission spectrum meets very closely but not necessarily exactly.)

In view of expectations that ideal, or “perfect,” performance may rarely if ever be achieved in many embodiments, a tolerance is set for small deviations of the filter's transmission spectrum from the ideal. (This tolerance may be denoted as a “preset tolerance” in the context of a series of steps to be described below.) The tolerance may be defined as the Root Mean Square (rms) from the L₂ (Euclidean) norm:

$$E = \sqrt{\frac{1}{N} {\sum }_{i = 1}^{N} {( {T}_{i} - {t}_{t} )}^{2}}$$

as the maximum difference between the ideal (T) and the computed (t) transmissions over N wavelengths. The spectrum 40 in FIG. 6 (not to scale) is an example of an acceptable (near-ideal) spectrum. The filter is designed for transmissions having wavelengths between a wavelength a and a wavelength d. Outside the region, the transmittance may be noticeably greater than zero, but such is not a problem for the filter's intended use in this embodiment.

The filter 36 is built with multiple thin film layers 42a₁, 42b₁, 42a₂, 42b₂, 42a₃, 42b₃, . . . such that each layer is made of one of two different selected materials having different indices of refraction. (For clarity, only a subset of the total number of layers is illustrated in FIG. 5.) That is, layers 42a₁, 42a₂, 42a₃, . . . are made from one material a having a lower refractive index, and layers 42b₁, 42b₂, 42b₃, . . . are made from another material b having a higher refractive index material. The thin films are added layer upon layer so that, except for the end layers, each layer of one material is positioned between two layers of the other material.

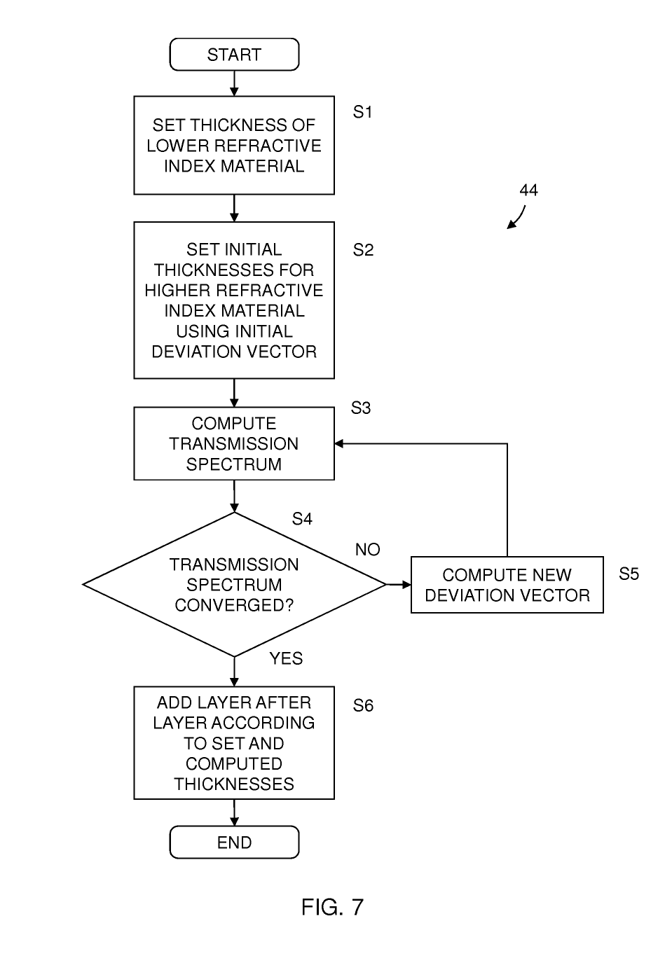

Useful guidelines for selecting the materials include: (1) selecting a combination of materials that provide a desired band-gap structure (at least one full transmission zone within a predetermined range of wavelengths); and (2) selecting materials in which the difference between the respective refractive indices is large enough to allow designing filters to have very small thicknesses. As a non-limiting example, the material having the lower refractive index may be silicon oxide (SiO₂), having a refractive index of approximately 1.47 at room temperature, and the material having the higher refractive index may be titanium oxide (TiO₂), having a refractive index of approximately 2.5 at room temperature. Another non-limiting example of material combinations is SiO₂ and silicon (Si), the latter having a refractive index of approximately 3.47 at room temperature. The method of building the multi-layer thin film filter is described further with reference to the flowchart 44 in FIG. 7.

In order to design the filter 36 so that its transmission spectrum is within the preset tolerance of the preselected transmission spectrum, the thicknesses for the individual layers 42a₁, 42b₁, 42a₂, 42b₂, 42a₃, 42b₃, . . . must be set appropriately. Initially, there are a preset number n of layers of the lower refractive index material and the same preset number n of layers of the higher refractive index material.

The preset number n is typically chosen based on the frequency range and the required bandwidth of the intended use. In the present embodiment, a goal is to have as few layers as possible, but as more layers produce narrower and sharper transmission spectra having more layers are sometimes justified to obtain desired filter performances. The values are often chosen based on experience (sometimes “trial-and-error”), but example guidelines at least for some uses include setting the average layer thickness to 0.2 μm and locating the required central frequency in the middle of the second zone, which is the widest band. Sometimes locating the central frequency in the middle of the second zone is not workable, for example, due to physical limitations or the Fabry-Perot resonances (discussed in more detail below), so the third or fourth zone may be chosen or even the first zone in the exceptional circumstances (when the layer thickness is expected to be very small). For a further discussion of an example empiric methodology for estimating the number of layers, reference is made to Willey, “Estimating the number of layers required and other properties of blocker and dichroic optical thin films,” Applied Optics, Vol. 35, No. 25, Sep. 1, 1996.

A first value tₐ is selected for the thicknesses of the layers that will be formed of the lower refractive index material. (Step S1.) An example guideline useful for setting the first value tₐ for layer thickness is to set it so that it is not so small as to make manufacturing homogeneous layers too difficult, perhaps not even possible, due to technological and/or physical limitations. Although manufacturing capabilities continually improve, thicknesses still need to be at least the atomic diameter of the material, which is approximately 0.4 nm for materials now used for thin film fabrication. Another example guideline for setting the layer thickness is that it is not so large, such as greater that 0.4 μm, that filter performance might degrade due to thermal and/or mechanical effects. An example of an undesired thermal effect is having different temperatures in different parts of the same layer, as the refraction index is temperature-dependent. An example of an undesired mechanical effect would be having a layer separate into multiple layers or from an adjacent layer, which would cause an increase in noise and decrease in transmittance. As a non-limiting example for a layer thickness, the value tₐ may be set at 0.1 μm.

Multiple calculations are executed to set the thicknesses of the thin film layers to be made of the higher refractive index material. These layers are not constrained to have equal thicknesses. That is, at least one of the layers 42b₁, 42b₂, 42b₃, . . . , 42b₂, may have a thickness that is not equal to the thickness of at least one of the other layers.

Accordingly, the initial values t_{b1}, t_{b2}, t_{b3}, . . . , tₙ for the thicknesses of each of the layers of the second material are set. (Step S2.) For purposes of subsequent calculations, these thicknesses are expressed as constant value t_{base} (a “second value”) plus an initial vector of deviations D. That is, the values t_{b1}, t_{b2}, t_{b3}, . . . , tₙ for the thicknesses for the thin film made from the higher refractive index material are expressed as t_{base}, the second value (a scalar), and the deviation vector D={d₁, d₂, . . . , dₙ}, such that t_{b1}=t_{base} d₁, t_{b2}=t_{base}+d₂, and so on as shown in FIG. 5. The thicknesses may be set according to principles discussed above. For convenience, the deviation vector may be set initially to zero, or as a sequence of the pseudo-random numbers, but such is not required in practicing the embodiment. As a non-limiting example for the second value t_{base} (that is, the thickness without deviation), the selection may be 0.1 μm.

Using the data discussed above, namely the preset number n of layers of each of the materials, their indices of refractions, the layer thicknesses expressed in terms of the first value tₐ, the second value t_{base}, and the deviation vector D, a transmission spectrum is computed by solving Maxwell's equations. (Step S3.) Maxwell solvers (computer implementations of numerical algorithms for solving Maxwell's equations) may be used for this purpose. One type of Maxwell solver employs a finite difference time domain (FDTD) method to model electromagnetic wave propagation through a dielectric structure with a variable (space dependent) refractive index. Commercial software is available for this purpose, and examples of such software include RSoft (www.rsoftdesign.com) and VORPAL (http://www.txcorp.com/products/VORPAL/index.php). Alternatively, the semi-analytic transfer matrix method (TMM) could be used as a Maxwell solver to compute the transmission/reflection spectrum, if the system can be considered to be quasi-one-dimensional, that is, the thickness in the direction of wave propagation is much smaller than the filter dimensions normal to the direction of wave propagation). Maxwell solvers may be executed for example on general purpose computers or work stations, and may be executed on servers accessible through networks, such as the Internet or a local area network (LAN).

It is then determined whether the computed transmission spectrum has converged to within the preset tolerance of the preselected transmission spectrum. (Step S4.) One way to make this determination is to compute an L₂ norm based on the differences between the computed and desired transmission spectra and then to compare this L₂ norm to the preset tolerance expressed in terms of an L₂ norm as discussed above. The preset tolerance may be regarded as simply a small number, for example, less than 1×10⁻⁶, and often corresponding to the resolution of a filter performance measurement device (a spectrometer).

If the computed transmission spectrum is not within the preset tolerance of the preselected transmission spectrum, the thicknesses of at least some of the thin film layers needs to change. Accordingly, a non-linear optimization algorithm is executed to compute a new deviation vector D such that a new computed transmission spectrum will be closer to the preselected transmission spectrum. (Step S5.) One type of non-linear optimization is based a least squares calculation that is constrained so that individual layer deviations are between preset minimum and maximum values dₘᵢₙ and dₘₐₓ. Another way to compute the new deviation vector D implements subspace trust-region non-linear optimization based on the interior-reflective Newton method, for example, as discussed in Coleman et al., “On the convergence of interior-reflective Newton methods for nonlinear minimization subject to bounds,” Mathematical Programming 67 (1994) 189-224, The Mathematical Programming Society, Inc. Each iteration during the optimization process involves the approximate solution of a large linear system using preconditioned conjugate gradients. Yet another optimization method uses a simulated annealing algorithm, which is a probabilistic approach, and an example of such is disclosed in Haddock et al., “Simulation Optimization Using Simulated Annealing,” Computers ind. Engng, Vol. 22, No. 4, pp. 387-95, 1992. The non-linear optimization algorithms may be executed on general purpose computers or work stations and may be executed on servers accessible through networks.

The preset minimum value dₘᵢₙ for layer thickness deviations may be set based on manufacturing limitations, for example, as a negative number whose absolute value is slightly less than the second material layer value t_{base}. For example, the sum of the preset minimum value dₘᵢₙ and the second material layer value t_{base} could be set to provide that the minimum thickness for any layer of the second material is equal to the atomic diameter of the material. Common machines used for the thin film deposition can theoretically produce films of approximately 0.4 nm thickness, but generally a thickness of approximately 20 nm is considered as a minimal thickness for a layer. Accordingly, an example minimum value dₘᵢₙ (a negative number) can be set such that t_{base}+dₘᵢₙ>20 nm.

The preset maximum value dₘₐₓ for layer thickness deviations may be set so that its sum with the second value t_{base} is still thin enough so that the layer properties, for example, heat distribution, remain constant in a layer in the direction of light propagation. Also, the layers should be thin enough to reduce the risk of adhesion failure (layer debonding), which is more of a qualitative than a quantitative assessment.

After executing the non-linear optimization algorithm to compute the new deviation vector D, the process flow returns to step S3 and a new transmission spectrum is computed based on the new deviation vector D along with the first and second values tₐ, t_{base}. It is then determined whether this recomputed transmission spectrum is within the preset tolerance of the preselected transmission spectrum 38. (Step S4.) The method of the present embodiment may include repeatedly solving Maxwell's equations (step S3) and executing the non-linear optimization algorithm (step S5) many times until the deviation vector converges to a final deviation vector such that the computed transmission spectrum converges to within the preset tolerance of the preselected transmission spectrum 38. At that point, the response to the step S4 inquiry will be affirmative.

Then, by knowing the first value tₐ, the second value t_{base}, and the final deviation vector D, the thicknesses for the layers are set, and a filter with an acceptable transmission spectrum can be built. The thicknesses of the layers of the first material are equal to the first value tₐ, and the thicknesses of the layers of the second material are equal to sum of the second value t_{base} plus the deviations of the final deviation vector D. A first layer 42b₁ (FIG. 5) of the higher refractive index material is formed. Then, another layer 42b₁ of the lower refractive index material is added to the first layer 42b₁. Additional layers are formed, repeatedly adding layers alternating between the higher and lower refractive index materials, until all the layers are added according to the set computed thicknesses. (Step S6.)

One way to form the layers is by deposition, such as by plating or vaporing. As a non-limiting example, the materials of the layers may be SiO₂ and TiO₂. As another non-limiting example, the materials of the layers may be SiO₂ and Si.

After all the layers are added according to the first value tₐ, the second value t_{base}, and the final deviation vector D, a final layer 42b_{end} of the higher refractive index material is layered upon the lower refractive index material and the process then ends. The value for the thickness of this final layer 42b_{end} is not used in the previously-described calculations.

In some situations, the cycle of optimization steps S3, S4, and S5 may repeat so many times so as to risk algorithm stagnation, that is, convergence to a local minimum or no convergence at all. In view of such risk, the embodiment may be implemented with a set maximum number of iterations and maximum number of function evaluations to avoid the optimization algorithm stagnation. Accordingly, when after a preset number of cycles the computed transmission spectrum does not converge to within the preset tolerance of the preselected transmission spectrum, this implementation includes adding a number m (at least one) to the preset number n of layers of both materials; and (2) adding the same number m additional deviation components dᵢ to the deviation vector D. Then, the cycle of optimization resumes. That is, the thicknesses of the individual filter layers are computed by solving Maxwell's equations (step S3), the recomputed transmission spectrum is checked to see whether it has converged to within the preset tolerance of the preselected transmission spectrum (step S4), and, if the convergence is not adequate, the non-linear optimization algorithm is executed based on the new numbers of layers and new deviation components to compute a new deviation vector (step S5).

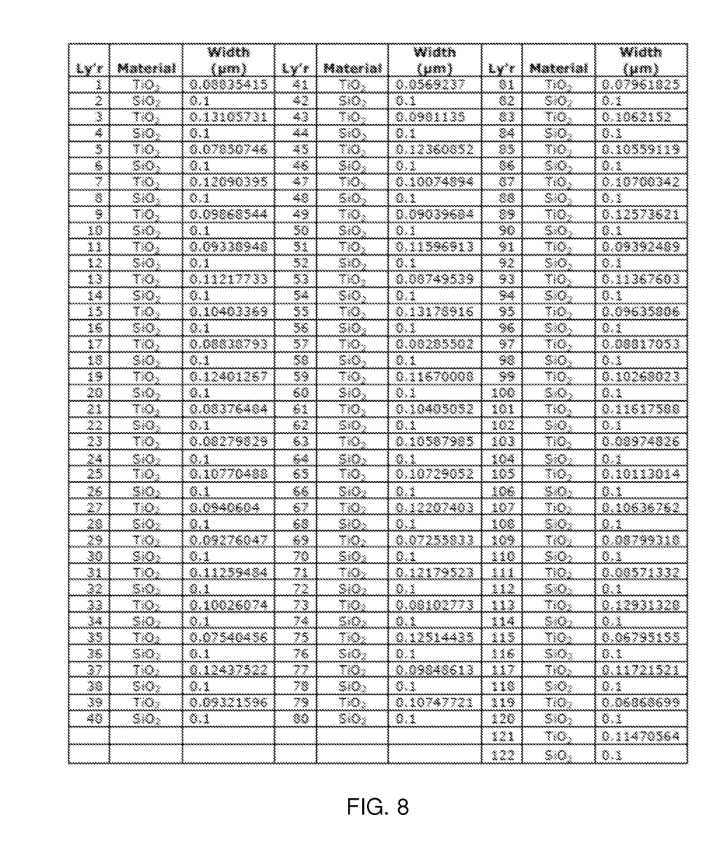

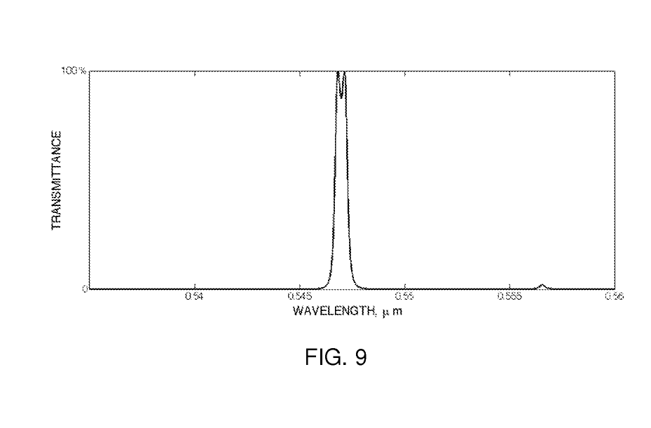

The table is FIG. 8 provides the thicknesses of layers of a multi-layer thin film filter built according to the first embodiment such that its computed transmission spectrum has converged to within a preset tolerance of a preselected transmission spectrum. The higher refractive index material is TiO₂ and the lower refractive index material is SiO₂. For each layer of the multi-layer thin film filter, its material and thickness are specified in the table. A plot of the spectrum computed for this multi-layer thin film filter is shown in FIG. 9.

Some embodiments of the present invention include a step of determining whether, based on the first value tₐ and the index of refraction nₐ of the material having the lower refractive index, the transmission spectrum includes wavelengths in which the filter exhibits a Fabry-Perot resonance. Such resonance occurs when the following relation holds:

tₐ=sλ/2nₐ

where s is an integer 1, 2, 3, . . . and λ is the wavelength of the intended use. If it is determined that transmission spectrum includes a Fabry-Perot resonance frequency, a different filter is designed for example by changing the thickness tₐ of the layer having the material of the lower refractive index nₐ.

The invention may also be embodied as a multi-layer thin film filter having a transmission spectrum that is within a preset tolerance of a preselected transmission spectrum. Such an example is illustrated as filter 36 in FIG. 5. The filter 36 includes spaced apart layers 42a₁, 42a₂, 42a₃, . . . , and layers 42b₂, 42b₃, . . . space apart the layers 42a₁, 42a₂, 42a₃, . . . . The outer sides are layers 42b₁ and 42b_{end}. Layers 42b₁, 42b₂, 42b₃, . . . , 42b_{end} are made from a material that has a higher refractive index than that of the material from which 42a₁, 42a₂, 42a₃, . . . are made. The thicknesses of the individual layers may be set according to the process represented by the flowchart 44 in FIG. 7 or by variations thereof.

Besides the usage of embodiments of the invention as filters in wavelength division multiplexing systems as discussed earlier, embodiments of the invention have other uses as well. For example, the filters may function as antireflective coatings, such as on the surface of lenses to thereby reduce undesired reflection. Color CCD or CMOS imagers may use the filters to block the transmission of infrared waves while permitting the passage of visible light. The filters may alternatively be used for electromagnetic interference shielding to block parasitic electromagnetic fields generated by electronic equipment such as in electric circuits or interconnects, as non-limiting examples. Embodiments of the filters may be designed instead as coatings to reduce flare/ghosting in lenses. Also, the filters may be used in the hydrogenated amorphous silicon (a-Si) solar cells to improve the light trapping.

Having thus described exemplary embodiments of the invention, it will be apparent that various alterations, modifications, and improvements will readily occur to those skilled in the art. Alternations, modifications, and improvements of the disclosed invention, though not expressly described above, are nonetheless intended and implied to be within spirit and scope of the invention. Accordingly, the foregoing discussion is intended to be illustrative only; the invention is limited and defined only by the following claims and equivalents thereto.

1. A method of building a multi-layer thin film filter to have a transmission spectrum that is within a preset tolerance of a preselected transmission spectrum, the filter having layers of a lower refractive index material and layers of a higher refractive index material, the method comprising:
setting thicknesses of individual layers by (1) selecting a first value for the thickness of a preset number of layers of the lower refractive index material and (2) computing the thicknesses of the same preset number of individual layers of the higher refractive index material by:
setting initial values for the thicknesses of each of the layers, the thicknesses being expressed as a second value plus an initial vector of deviations;
computing a transmission spectrum by solving Maxell's equations based on the first value, the second value, and the deviation vector;
executing a non-linear optimization algorithm to compute a new deviation vector such that a new computed transmission spectrum is closer to the preselected transmission spectrum, the non-linear optimization algorithm constrained to suggest individual layer deviations that are between preset minimum and maximum values; and
repeatedly solving Maxwell's equations and executing the non-linear optimization algorithm until the deviation vector converges to a final deviation vector such that the computed transmission spectrum converges to within the preset tolerance of the preselected transmission spectrum;
forming a first layer of the higher refractive index material;
adding to the first layer a layer the lower refractive index material; and
repeatedly adding layers alternating between the higher and lower refractive index materials;
wherein the thicknesses of the layers of the lower refractive index material are equal to the first value and the thicknesses of the layers of the higher refractive index material are equal to the second value plus the deviations of the final deviation vector.

2. The method of claim 1, wherein the initial deviation vector is equal to zero.

3. The method of claim 1, wherein, when after a preset number of cycles the computed transmission spectrum does not converge to within the preset tolerance of the preselected transmission spectrum, the method further includes:
adding at least one layer to the preset number of layers of both materials;
adding at least one additional deviation component to the deviation vector; and
computing of the thicknesses of the individual layers by solving Maxwell's equations and executing the non-linear optimization algorithm based on the new numbers of layers and deviation components.

4. The method of claim 1 further comprising:
determining whether, based on the first value and the index of refraction of the material having the lower refractive index, the transmission spectrum includes a wavelength in which the filter exhibits a Fabry-Perot resonance.

5. The method of claim 1, wherein the second value and the preset minimum value are set so that the minimum thickness of a layer of the higher refractive index material is the atomic diameter of the higher refractive index material.

6. The method of claim 1, wherein the second value and the preset maximum value are set so that the maximum thickness of a layer of the higher refractive index material is so that the layer properties remain constant in the direction of light propagation.

7. The method of claim 1, wherein the layers are formed by deposition.

8-14. (canceled)
